(19) United States
(12) Patent Application Publication
(10) Pub. No.: US 2006/0261743 A1
(43) Pub. Date: Nov. 23, 2006

(54) PLASMA DISPLAY PANEL

(75) Inventors: Tae-Joung Kweon, Suwon-si (KR); Kyoung-Doo Kang, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD., Suwon-si (KR)

(21) Appl. No.: 11/383,284

(22) Filed: May 15, 2006

(30) Foreign Application Priority Data
May 20, 2005 (KR) 10-2005-0042417

(51) Int. Cl. G09G 3/10

(52) U.S. Cl. 315/169.3

(57) ABSTRACT

A plasma display panel (PDP) including a plurality of discharge cells defined by a front substrate, a rear substrate, and a dielectric wall with a plurality of unit dielectric walls, phosphor layers and discharge gas disposed in the discharge cells, a plurality of discharge electrodes disposed within the dielectric wall, and a plurality of address electrodes disposed within the dielectric wall and spaced a predetermined distance from the discharge electrodes. The address electrodes extend parallel to each other and have a plurality of first discharge units that each corresponding to a discharge cell. Each first discharge unit partially surrounds a discharge cell, and successive first discharge units are coupled together by second discharge units. Adjacent address electrodes are spaced apart by at least the width of a discharge cell to reduce power consumption and heat generation during driving, and discharge electrodes do not block emission of visible light.

### CROSS REFERENCE TO RELATED APPLICATION

This application claims priority to and the benefit of Korean Patent Application No. 10-2005-0042417, filed on May 20, 2005, which is hereby incorporated by reference for all purposes as if fully set forth herein.

### BACKGROUND OF THE INVENTION

1. Field of the Invention

The present invention relates to a plasma display panel, and more particularly, to a plasma display panel with an increased sustain discharge intensity and with a lower driving voltage by inducing a three dimensional discharge, and that significantly improves brightness by increasing the emission efficiency of visible light.

2. Discussion of the Background

Plasma display panels (PDPs) can be classified as direct current (DC) PDPs, alternating current (AC) PDPs, or hybrid PDPs according to the behavior of charge migration between electrodes. PDPs can further be classified as facing discharge PDPs or surface discharge PDPs according to their electrode structure. In DC PDPs, electrodes are exposed to a discharge space and charges migrate directly between corresponding electrodes. Conversely, in AC PDPs at least one electrode is surrounded and protected by a dielectric layer, and discharge is generated by an electric field of wall charges.

In DC PDPs, the electrodes may be damaged by the direct migration of charges between corresponding electrodes. Therefore, AC PDPs with a three-electrode surface discharge structure have become increasingly popular in the consumer electronics marketplace.

FIG. 1 is a partial perspective view of a conventional three-electrode surface discharge PDP as disclosed in Japanese Patent Laid-Open publication 1997-172442. Referring to FIG. 1, a conventional PDP 10 includes a front substrate 20 and a rear substrate 30. Address electrodes 33 formed on the rear substrate 30 generate an address discharge, a rear dielectric layer 35 covers and protects the address electrodes 33, a plurality of barrier ribs 37 define discharge cells 15, and phosphor layers 39 coat the sidewalls of the barrier ribs 37 and the rear dielectric layer 35 between the barrier ribs 37 facing the front substrate 20. On a lower surface of the front substrate 20, which faces the rear substrate 30, X electrodes 22 and Y electrodes 23 generate a sustaining discharge, a front dielectric layer 25 covers and protects the X electrodes 22 and Y electrodes 23, and a protection film 29 covers the front dielectric layer 25. The X electrode 22 can include a transparent X electrode 22a and a bus X electrode 22b disposed on and coupled to one side of the transparent X electrode 22a, and the Y electrode 23 can include a transparent Y electrode 23a and a bus Y electrode 23b disposed on and coupled to one side of the transparent Y electrode 23a.

n a PDP having the above structure, ions collide with the phosphor layer 39 in a discharge cell 15 due to a sustain discharge generated between the X electrode 22 and Y electrode 23 and corresponding to the discharge cell 15. The excited phosphor layer 39 emits visible light through the front substrate 20 and then outside the PDP, thereby forming an image.

However, in a conventional PDP 10, the X electrode 22, the Y electrode 23, the front dielectric layer 25 and the protection film 29 are sequentially formed on a lower surface of the front substrate 20. Therefore, the transmittance of visible light out of the PDP may be approximately 60% of the visible light actually emitted from the phosphor layer 39.

Also, in a conventional PDP 10, since the X electrodes 22 and the Y electrodes 23 are disposed on the lower surface of the front substrate 20a large portion of each X electrode 22 and Y electrode 23 is generally formed of transparent material such as ITO to maximize transmission of light out of the PDP. However, ITO has high resistance and can be expensive and difficult to manufacture. As a result, electrodes formed of ITO may cause a voltage drop along the length of the electrodes, which may cause generation of a non-uniform image on a large PDP, and may also require high manufacturing costs.

Also, in a conventional PDP 10, sustain discharge may be concentrated near a lower surface of the front substrate 20, proximate to the X electrode 22 and Y electrode 23. Accordingly, the space of the discharge cell 15 is not used efficiently to generate a high efficiency sustain discharge.

Also, since integrated circuit chips account for a large portion of the total manufacturing cost of the PDP 10 and since integrated circuit chips that may withstand high voltages are expensive to manufacture, the driving voltage should not be excessively high. However, with lower driving voltages, the distance between an X electrode 22 and a corresponding Y electrode 23 is limited, thereby limiting the amount of discharge. Accordingly, the brightness of emitted visible light is also limited.

Finally, when a conventional PDP 10 operates for an extended period of time, ion sputtering near the phosphor layer 39 may occur since charged particles of discharge gas diffuse from the lower surface of the front substrate 20 toward the phosphor layer 39 by an electric field. This may result in the formation of a permanent latent image, or burn-in, in the phosphor layer 39 of the PDP 10.

### SUMMARY OF THE INVENTION

This invention provides a plasma display panel that increases brightness and improves the emission of visible light by minimizing the number of elements on the emission path of visible light.

This invention also provides a plasma display panel with an increased sustain discharge intensity and a lower driving voltage by inducing a three dimensional discharge.

This invention also provides a plasma display panel that can be manufactured at a lower cost without using ITO electrodes.

This invention also provides a plasma display panel with an increased life expectancy of a phosphor by preventing ion sputtering to the phosphor.

This invention also provides a plasma display panel having a structure that reduces the generation of heat in address electrodes.

Additional features of the invention will be set forth in the description which follows, and in part will be apparent from the description, or may be learned by practice of the invention.

The present invention discloses a plasma display panel including a front substrate, a rear substrate facing the front substrate, a dielectric wall disposed between the front substrate and the rear substrate and including a first unit dielectric wall and a second unit dielectric wall, the dielectric wall defining a plurality of discharge cells, a front discharge electrode disposed within the dielectric wall, a rear discharge electrode disposed within the dielectric wall, a first address electrode disposed within the dielectric wall, and having a portion corresponding to and partially surrounding a discharge cell, a phosphor layer disposed in the discharge cell, and a discharge gas disposed in the discharge cell.

The present invention also discloses a plasma display panel including a front substrate, a rear substrate facing the front substrate, a dielectric wall disposed between the front substrate and the rear substrate and including a plurality of unit dielectric walls that define discharge cells in a first direction, a first discharge electrode and a second discharge electrode disposed within the dielectric wall, a phosphor layer disposed in a discharge cell, and a discharge gas disposed in the discharge cell. Further, the first discharge electrode has a portion corresponding to and partially surrounding a perimeter of the discharge cell.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a partially exploded perspective view of a conventional PDP.

FIG. 2 is a partially exploded perspective view of a PDP according to an exemplary embodiment of the present invention.

FIG. 3 is a perspective view illustrating the electrode arrangement of the PDP shown in FIG. 2.

FIG. 4 is a cross-sectional view taken along line IV-IV of the PDP shown in FIG. 2.

FIG. 5A is a horizontal cross-sectional view of an address electrode structure for the PDP shown in FIG. 2.

FIG. 5B is a conceptual drawing of the address electrode of FIG. 5A.

FIG. 6A is a cross-sectional view of a comparative example of FIG. 5A.

FIG. 6B is a conceptual drawing of the address electrode of FIG. 6A.

FIG. 7A and FIG. 7B are cross-sectional views of additional embodiments of the address electrode structure shown in FIG. 5A.

FIG. 8 is a block diagram showing the configuration of a plasma display device having the PDP shown in FIG. 2.

FIG. 9 is a partial exploded perspective view of a PDP according to a second exemplary embodiment of the present invention.

FIG. 10 is a perspective view illustrating the electrode arrangement of the PDP shown in FIG. 9.

FIG. 11 is a cross-sectional view taken along line X-X of the PDP shown in FIG. 9.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

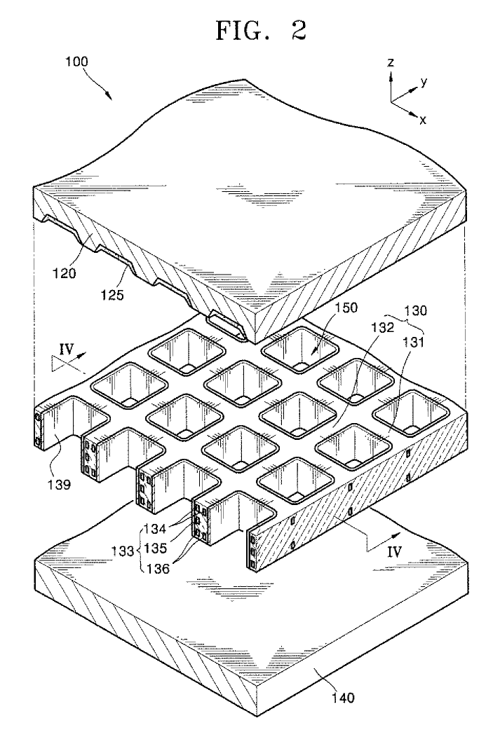

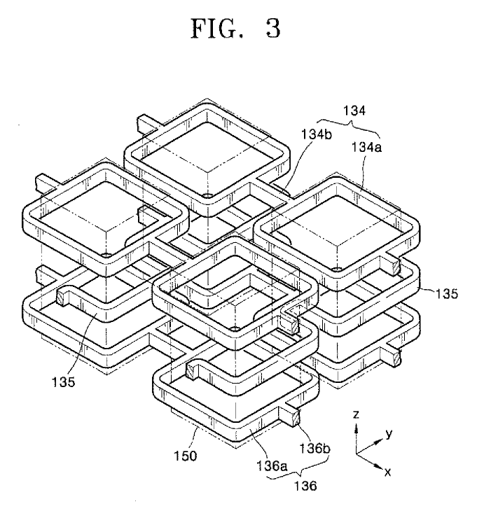

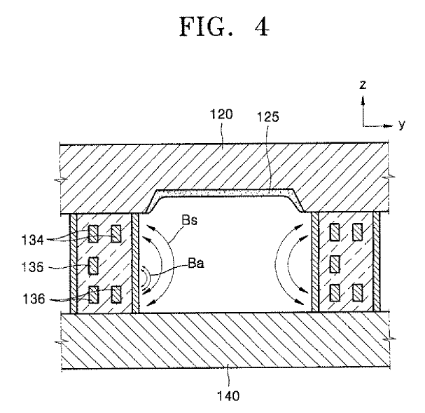

FIG. 2 is a partially exploded perspective view of a PDP according to an exemplary embodiment of the present invention. FIG. 3 is a perspective view illustrating the electrode arrangement of the PDP shown in FIG. 2. FIG. 4 is a cross-sectional view taken along line IV-IV of the PDP shown in FIG. 2.

Referring to FIG. 2, FIG. 3, and FIG. 4, a PDP 100 according to an exemplary embodiment of the present invention includes a front substrate 120, electrode groups 133 including front discharge electrodes 134, rear discharge electrodes 136, and address electrodes 135, a rear substrate 140, dielectric walls 130, phosphor layers 125, and a discharge gas (not shown).

The front substrate 120 may be formed of a transparent material and may be parallel to and spaced apart from the rear substrate 140. Grooves may be formed in a surface of the front substrate 120, and phosphor layers 125 can be formed in the grooves. The present invention is not limited thereto, and the location of the phosphor layer 125 is not limited to the front substrate 120 but can be disposed in other regions of discharge cells 150 or the PDP. The rear substrate 140 can be formed of substantially the same material or a different material as the front substrate 120.

The dielectric walls 130 can be interposed between the front substrate 120 and the rear substrate 140 to define discharge cells 150 together with the front substrate 120 and the rear substrate 140. A discharge cell 150 refers to a region in the PDP 100 in which discharge is generated. The dielectric walls 130 can be formed of a plurality of first unit dielectric walls 131 and second unit dielectric walls 132 that define the discharge cells 150. As shown in FIG. 2, the dielectric walls 130 can include a plurality of first unit dielectric walls 131 extending in a first direction (shown as the x axis in FIG. 2), and a plurality of second unit dielectric walls 132 extending in a second direction (shown as the y axis in FIG. 2).

In this case, as shown in FIG. 2, the dielectric walls 130 can define the discharge cells 150 in a lattice or matrix shape by being oriented in the x axis and y axis. However, the present invention is not limited thereto, and the dielectric walls 130 can take any form, such as a circular shape, a triangular shape, a hexagonal shape, or a honeycomb shape. Additionally, a plurality of first unit dielectric walls 131 extending in a first direction and a plurality of second unit dielectric walls 132 extending in a second direction need not be perpendicular and can cross with each other at an oblique angle. Accordingly, the discharge cells 150 defined by the dielectric walls 130 can be any shape, such as polygonal or circular.

The dielectric walls 130 may prevent cross-talk between the discharge cells 150, and may also protect the electrodes in the electrode group 133 from damage from collision with positive ions or electrons during sustain discharge. Therefore, the dielectric wall 130 may be formed of a dielectric material to attract and induce charges.

Electrode groups 133 are disposed in and covered by the dielectric wall 130. An electrode group 133 may include the front discharge electrode 134, the address electrode 135, and the rear discharge electrode 136 spaced apart from each other in a vertical direction (shown as the z direction in FIG. 2). The front discharge electrode 134 may extend in a first direction and be disposed parallel to the rear discharge electrode 136, and the address electrode 135 may extend in a second direction to cross with the front discharge electrode 134 and the rear discharge electrode 136.

The address electrode 135 may generate an address discharge (shown as Ba in FIG. 4) which assists the generation of a sustain discharge (shown as Bs in FIG. 4). More specifically, the address electrode 135 may reduce the breakdown voltage for generating the sustain discharge. The front discharge electrode 134 and the rear discharge electrode 136 generate the sustain discharge Bs therebetween, and either the front discharge electrode 134 or the rear discharge electrode 136 may function as a scan electrode and the other may function as a common electrode.

As shown in FIG. 4, the address discharge Ba is generated between the rear discharge electrode 136, serving as a scan electrode, and the address electrode 135. When the address discharge is completed, positive ions accumulate proximate to the scan electrode and electrons accumulate proximate to the common electrode side. The accumulation of these charges then facilitates the generation of the sustain discharge between the scan electrode and the common electrode.

As the scan electrode is positioned closer to the address electrode 135, the voltage required to generate address discharge decreases. Therefore, as shown in FIG. 2 and FIG. 3, the front discharge electrodes 134, the address electrodes 135, and the rear discharge electrodes 136 can be sequentially disposed in a vertical direction from the front substrate 120, and the discharge electrode that is positioned closer to the address electrodes 135 may function as the scan electrode.

Further, the front discharge electrodes 134 and the rear discharge electrodes 136 may extend in a first direction and the address electrodes 135 may extend in a second direction to cross with the front discharge electrodes 134 and the rear discharge electrodes 136. For example, as shown in FIG. 2 and FIG. 3, the front discharge electrodes 134 and the rear discharge electrodes 136 may extend in the x direction, and the address electrodes 135 may extend in the y direction.

The front discharge electrodes 134 and the rear discharge electrodes 136 may be protected by and positioned within the unit dielectric walls 132 that border two adjacent discharge cells 150, as shown in FIG. 2. The front discharge electrodes 134 can include a discharge cell corresponding unit 134a that surrounds a perimeter of a single discharge cell 150 and connection units 134b that connect successive discharge cell corresponding units 134a. The rear discharge electrodes 136 can include a discharge cell corresponding unit 136a that surrounds a perimeter of a single discharge cell 150 and connection units 136b that connect successive discharge cell corresponding units 136a. However, the present invention is not limited thereto, and the front discharge electrodes 134 can be formed as a series of trapezoidal shapes to surround discharge cells without connection units 134b between successive discharge cell corresponding units. Rear discharge electrodes 136 can be similarly formed. Therefore, one discharge cell corresponding unit can correspond to a discharge cell 150. Also, more than two discharge cell corresponding units 134a and 136a can be disposed in one unit dielectric wall 132.

The address electrodes 135 may be positioned to surround a portion of the discharge cell 150, but not completely surround the discharge cell 150. Specifically, the cross-section in the x-y plane (hereinafter, the horizontal cross-section) of the address electrode 135 corresponding to one discharge cell 150 may not close entirely and may leave open a portion of the perimeter of the discharge 150.

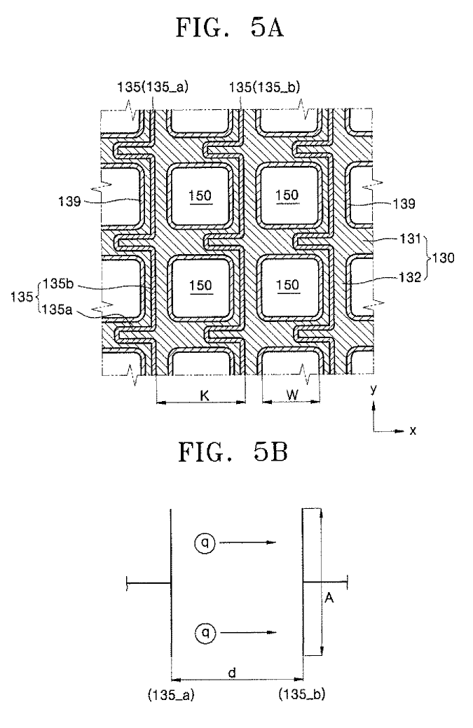

Thus, as shown in FIG. 5, an address electrode 135, extending parallel to adjacent address electrodes 135 in the y direction, can be formed separately in a second unit dielectric wall 132 also extending in the y direction. Accordingly, a first address electrode 135_{—}a corresponding to one discharge cell 150 and a second address electrode 135_{—}b adjacent to the first address electrode 135_{—}a may be separated by at least a width W in the first direction of the discharge cell 150. Therefore, as will be described in further detail later, a discharge current of the address electrode is not increased unnecessarily, thereby reducing power consumption and manufacturing cost.

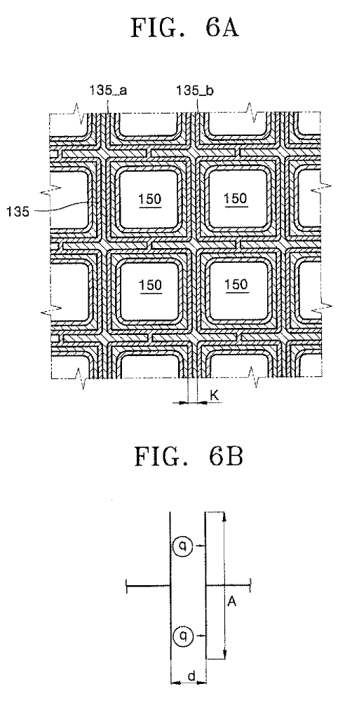

However, as shown in FIG. 6A, if the first address electrode 135_{—}a and the second address electrode 135_{—}b respectively corresponding to adjacent discharge cells 150 in the x direction are disposed in one unit dielectric wall 131 or one unit dielectric wall 132, a distance K between the adjacent address electrodes 135 is reduced.

As shown in FIG. 6A, a first address electrode 135_{—}a may function as a first polar plate, and a second adjacent address electrode 135_{—}b can function as a second polar plate. Together, the two polar plates may function as a capacitor.

The capacitance between the two parallel polar plates is expressed as

$$C = ɛ \frac{A}{d}$$

where, C is capacitance, d is the distance between the polar plates, A is the facing surface area of the polar plates, and ε is a dielectric constant. Accordingly, when the distance d between adjacent address electrodes 135 is reduced, the capacitance C increases since it is inversely proportional to the distance d. Also, when a predetermined address voltage is applied to a first address electrode 135_{—}a, a potential difference V is generated between that address electrode 135_{—}a and an adjacent address electrode 135_{—}b. Meanwhile, a charge q of a capacitor is proportional to capacitance C as expressed by the equation q=CV, and the charge q is proportional to current from the equation q=∫idt. Accordingly, when the capacitance C increases and voltage remains constant for generating an address discharge, the charge is increased, thereby increasing the current. When the current increases, power consumption increases according to the relationship shown by the formula P=V*i.

Therefore, the capacitance C between the address electrodes 135 shown in FIG. 6A and FIG. 6B, where distance K between address electrodes 135 is small, is greater than the capacitance C between the address electrodes shown in FIG. 5A and FIG. 5B, where distance K between the adjacent address electrodes 135 is larger. This increase in capacitance C results in an increase in power consumption and the generation of heat by the address electrodes 135. To solve this problem, high voltage resistance devices can be used at electrode terminals. However, this solution may significantly increase the manufacturing cost of the PDP 100.

Therefore, in the present exemplary embodiment, the capacitance C between the adjacent address electrodes 135 can be reduced by increasing the distance K between the adjacent address electrodes 135_{—}a and 135_{—}b as shown in FIG. 5A. Accordingly, the generation of heat by the address electrodes 135 can also be reduced, thereby reducing power consumption. The reduced power consumption also may allow for a smoother initial address discharge and increased control over an address voltage margin.

A first address electrode 135_{—}a can also be disposed in unit dielectric wall 131 and unit dielectric wall 132 as shown in FIG. 5A. An address electrode 135 corresponding to a discharge cell 150 can include a first discharge unit 135a and a second discharge unit 135b. The first discharge unit 135a can extend and return partially within a portion of the first unit dielectric wall 131 that defines the discharge cells 150, and the second discharge unit 135b can extend within the second unit dielectric wall 132 to couple between successive first discharge units 135a. The first discharge unit 135a and two successive second discharge units 135b can surround a portion of one discharge cell 150, and the address electrodes 135 corresponding to adjacent discharge cells 150 can be disposed at a predetermined distance, for example, the width W of the discharge cell 150 in the first direction shown in FIG. 5A.

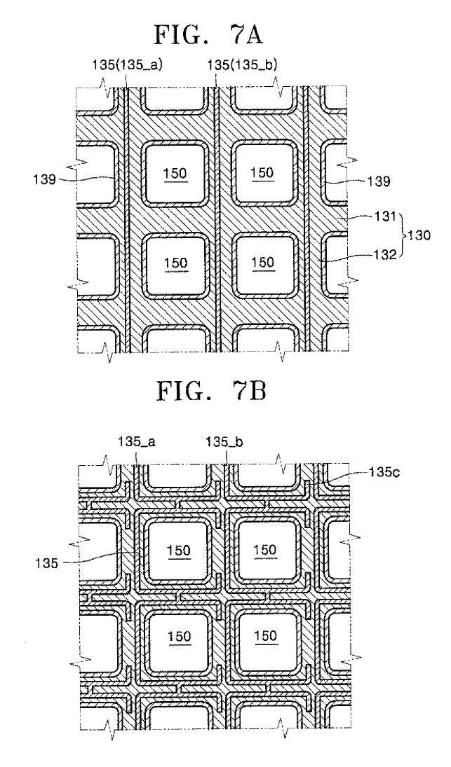

However, the present invention is not limited thereto, and as shown in FIG. 7A, the address electrodes 135 can extend in a straight line in the y direction without second discharge units 135b.

Furthermore, as shown in FIG. 7B, the address electrodes 135 can include a portion corresponding to two adjacent discharge cells 150 formed in the same second unit dielectric wall 132. The capacitance C of the address electrodes 135 can then be reduced by reducing the cross-sectional area A of minimum separation units 135c disposed in the second unit dielectric wall 132.

Referring back to FIG. 2, a protection film 139 formed of a material such as MgO is formed on a surface of the dielectric wall 130 and can emit secondary electrons through a reaction between the surface of the protection film 139 and ions generated in the front substrate 120 along four side surfaces of the discharge cell 150. The protection film 139 can be coated on a surface of the dielectric wall 130 in each discharge cell 150 or can be coated a rear portion of a discharge cell 150. For example, where the discharge cell 150 is defined on a lower surface by the rear substrate 140, the protection film 139 may be coated on a portion of the rear substrate 140 corresponding to the discharge cell 150.

A discharge gas, such as a Ne—Xe gas or a He—Xe gas, can fill the discharge cells 150.

Each element of the PDP having the above configuration according to the present invention and the operation thereof will now be described.

The front substrate 120 can be formed of a light transmitting material having a predetermined strength, such as soda glass or transparent plastic.

The electrode group 133 does not obscure the emission path of visible light since the electrode group 133 is disposed within the dielectric wall 130. Therefore, the electrodes included in the electrode group 133 do not need to be formed of transparent ITO, but can be formed of a material having high electrical conductivity, such as Ag, Cu, or Cr. Accordingly, uneven images and increased manufacturing costs can be avoided. Also, since the electrodes included in the electrode group 133 are disposed within the dielectric wall 130, and do not block the emission of visible light, the proportion of light emitted from the phosphor layer 125 to light emitted from the PDP may increase and brightness of the PDP may increase.

The dielectric wall 130 can be formed of glass having elements such as Pb, B, Si, Al, or O, or can be formed of a dielectric that includes a filler such as ZrO₂, TiO₂, or Al₂O₃ and a pigment such as Cr, Cu, Co, Fe, or TiO₂.

When a pulse voltage is applied to the electrodes of the electrode group 133, the dielectric wall 130 protects the electrodes of the electrode group 133 from damage due to collision with the charged particles accelerated during the discharge. The dielectric wall 130 also may enable sustain discharge driving through a memory effect by attracting wall charges that participate in the sustain discharge.

In the drawings, the discharge cells 150 may have rectangular cross-sections with smooth corners, but the present invention is not limited thereto, and the discharge cells 150 may have a different form, such as a polygon, a circle, or a honeycomb.

Additionally, the horizontal cross-section of the discharge cells 150 can have an open shape instead of a closed shape. However, when the horizontal cross-section of the discharge cells 150 has a closed shape, the quantity and efficiency of discharge may increase since the electrodes buried within the dielectric wall 130 can surround the discharge cell 150 and generate three dimensional sustain discharge.

The protection film 139 can be formed of MgO using a deposition method, or of a material having good secondary electron emitting characteristics and durability, such as Carbon NanoTubes (CNT), since the protection film 139 is not disposed on the emission path of the visible light.

The rear substrate 140 can be formed of soda glass like the front substrate 120. However, the rear substrate 140 may not be formed of transparent glass since it is not located on the emission path of the visible light generated from the discharge cells 150. The rear substrate 140 can also be formed of a material such as plastic or a metal for providing strength or reducing weight of the PDP.

The phosphor layers 125 can be divided into red phosphor layers, green phosphor layers, and blue phosphor layers so that the plasma display panel can generate a full color image, and a red phosphor layer, a green phosphor layer, and a blue phosphor layer can form a unit pixel that generates the color image.

The phosphor layers 125 can be formed of a phosphor paste with red light emitting phosphor material, green light emitting phosphor material, or blue light emitting phosphor material, a solvent, and a binder. The phosphor layers 125 can be formed in the PDP by drying and annealing the phosphor paste after placing the phosphor paste in grooves formed in the front substrate 120.

The red light emitting phosphor material can be (Y, Gd)BO₃:Eu³⁺, the green light emitting phosphor material can be Zn₂Si0₄:Mn²⁺, and the blue light emitting phosphor material can be BaMgAl₁₀O₇:Eu²⁺. However, the light emitting phosphor materials are not limited hereto.

Three discharge cells 150 including a red emitting phosphor layer, a green emitting phosphor layer, and a blue light emitting phosphor layer 125, can form a unit pixel, which generates an image by being arranged and emitting a combination of red light, green light, and blue light. However, to generate a color image, the discharge cells 150 of a unit pixel may be disposed in one direction, but are not limited thereto, and the widths and lengths of the discharge cells 150 can vary as necessary according to the light-emitting efficiency of the phosphor material and can have various shapes, such as a lattice shape or a delta shape.

The discharge gas filling the discharge cells 150 can be Ne gas, He gas, Ar gas that includes Xe gas, or a gas mixture of at least two of these gases. The front substrate 120 and the rear substrate 140 may be compressed together due to negative internal pressure when the discharge gas is at a pressure lower than atmospheric pressure, but the dielectric wall 130 can oppose the compressive forces and support the front substrate 120 and the rear substrate 140.

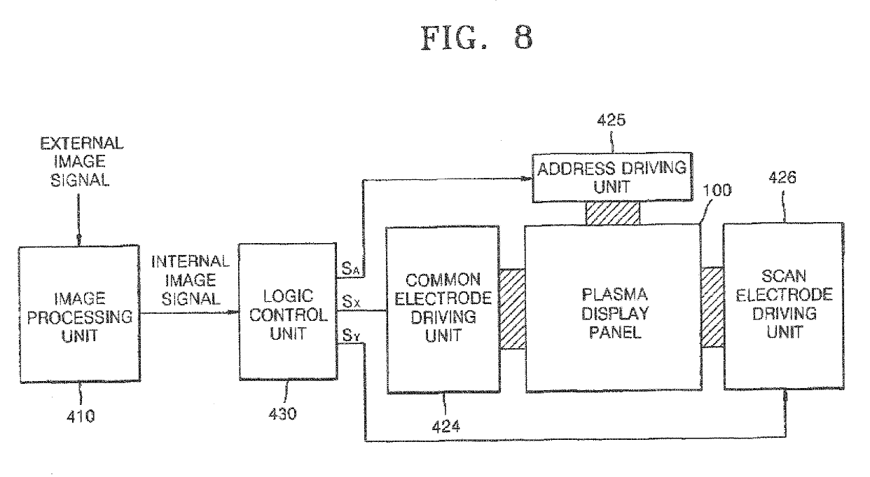

As shown in FIG. 8, a plasma display device having a PDP 100 according to an exemplary embodiment of the present invention may include an image processing unit 410, a logic control unit 430, an address driving unit 425, a common electrode driving unit 424, and a scan electrode driving unit 426. In the plasma display device with this configuration, an image can be displayed by the PDP 100 by applying an electric signal to the electrodes of the PDP 100 according to the following examples.

The image processing unit 410 receives and processes an external image signal to generate an internal image signal that may include digital data of red R, green G, and blue B colors, a clock signal, and vertical and horizontal synchronizing signals.

The logic control unit 430 generates drive-control signals S_{A}, S_{Y}, and S_{X} according to the internal image signals received from the image processing unit 410. The address driving unit 425 generates electrical signals, which may be voltage signals, by processing the address signals S_{A} received from the logic control unit 430 and applies the electrical signals to the address electrodes 135.

The common electrode driving unit 424 drives the common electrodes which may be the front discharge electrodes 134, according to the common electrode driving-control signal S_{X} received from the logic control unit 430. The scan electrode driving unit 426 drives the scan electrodes, which may be the rear discharge electrodes 136, according to the scan electrode driving-control signal S_{Y} received from the logic control unit 430.

The ends of the front discharge electrodes 134 may be electrically coupled together to share electrical signals applied to the front discharge electrodes 134. The electrical signals may be applied as voltage signals from the common electrode driving unit 424.

When the ends of the front discharge electrodes 134 are electrically coupled together, ends of the rear discharge electrodes 136 may be separated from each other so electrical signals, which may be voltage signals received from the scan electrode driving unit 426, are supplied to individual rear discharge electrodes 136 and not supplied in common.

A method of driving a PDP 100 and the function of the electrodes in the electrode group 133 included in the PDP 100 will now be described. While not limited hereto, the following description shall presume that the rear discharge electrodes 136 function as scan electrodes and the front discharge electrodes 134 function as common electrodes. The method of driving the PDP 100 depicted in FIG. 2 through FIG. 7B can include Address-Display-Separated (ADS) driving, Alternate Lighting of Surfaces (ALIS) driving, or Address-While-Display (AWD) driving, and factors such as image quality and response speed of the PDP 100 may vary according to the method of driving. However, the selected method of driving the plasma display panel does not alter the present invention. Therefore, hereinafter, the driving of the PDP 100 according to the present invention will be described using the ADS driving method.

Generally, to display an image on a display device, discharge is generated in each of the discharge cells 150 in the PDP 100. However, after discharge, each of the discharge cells 150 may have a different state of wall charge or different amount of charged particles. The different states of the discharge cells 150 complicate the achievement of uniform discharge.

To avoid this uncertainty and improve discharge control, wall charges can be removed from the discharge cells 150 and the charged particles in the discharge cells 150 can be made uniform by simultaneously applying a predetermined high voltage to all the discharge cells 150 to generate a discharge. This discharge is called a reset discharge.

The reset discharge in all discharge cells 150 is performed by applying a high ramp voltage to the rear discharge electrodes 136, a ground potential to the address electrodes 135, and a bias potential to the front discharge electrodes 134 for a predetermined time.

An address discharge Ba is then generated after the reset discharge. Discharge cells 150 on which an image is to be displayed are selected at points where rear discharge electrodes 136 crosses with address electrodes 135a. Then, a pulse voltage having a predetermined polarity is applied to the rear discharge electrodes 136, and a voltage having a polarity opposite to the predetermined polarity of the rear discharge electrodes 136 is applied to the address electrodes 135. As a result of the voltage difference between the rear discharge electrodes 136 and the address electrodes 135, an address discharge Ba is generated and charged particles or wall charges accumulate on inner sidewalls of the dielectric wall 130 in the discharge cells 150.

To create the address discharge in the selected discharge cells 150 as described above, a predetermined voltage must be applied to the address electrodes 135 and the rear discharge electrodes 136. To facilitate the generation of address discharge, rear discharge electrodes 136 may be disposed close to the address electrodes 135 to increase the magnitude of an electric field formed by the predetermined voltages applied to the rear discharge electrodes 136 and the address electrodes 135.

Accordingly, positioning the rear discharge electrodes 136 close to the address electrodes 135 allows the driving voltage for generating a desired address discharge to be reduced. The reduction of the driving voltage allows the use of inexpensive integrated circuit chips to drive the address electrodes 135, thereby reducing manufacturing cost for the PDP 100.

Also, since adjacent address electrodes 135 corresponding to adjacent discharge cells 150 in the x direction are separated by at least a width of the discharge cells 150, the capacitance between the adjacent address electrodes 135 is reduced, which also reduces power consumption during the address discharge as well as the generation of heat by the address electrodes 135.

Further, after the address discharge is generated in the selected discharge cells 150, a high voltage pulse is applied to the rear discharge electrodes 136 and a relatively low voltage pulse is applied to the front discharge electrodes 134. The wall charges accumulated on the inner sidewalls of the discharge cells 150 during the address discharge migrate due to the potential difference between the front discharge electrodes 134 and the rear discharge electrodes 136. The discharge gas atoms in the discharge cells 150 collide with the migrating wall charges to generate a sustain discharge and produce plasma. Relatively strong electric fields are formed where the front discharge electrodes 134 and the rear discharge electrodes 136 are close to each other, which is where sustain discharge may commence.

In the PDP 100 according to an exemplary embodiment of the present invention, the electrodes of the electrode group 133 may surround the discharge cells 150 by being positioned inside the dielectric wall 130. Accordingly, sustain discharge may occur on the sidewalls of the discharge cells 150 at a region where the front discharge electrodes 134 and the rear discharge electrodes 136 are positioned. Therefore, sustain discharge can commence along all four sidewalls of the discharge cells 150 and diffuse to the center of the discharge cells 150, unlike in the conventional alternating current type three-electrode surface discharge PDP, thereby greatly increasing the possibility of occurrence of the sustain discharge and the intensity of sustain discharge.

Also, when the sustain discharge is successfully generated along the sidewalls of the discharge cells 150 and the potential difference between the front discharge electrodes 134 and the rear discharge electrodes 136 is maintained for a predetermined time, the electric fields formed on the sidewalls are heavily concentrated on the center regions of each discharge cell 150. Thus, the region over which sustain discharge occurs is increased compared to a conventional PDP, thereby increasing the generation of ultraviolet rays.

Also, since the electric field is heavily concentrated in the center region of each discharge cell 150, fewer charged particles accelerate toward the phosphor layer 125 than in the conventional alternating current type three-electrode surface discharge PDP. Thus, ion sputtering damage to the phosphor layer 125 may be reduced, which may prevent burn-in and increase the lifespan of the phosphor layer 125.

The ultraviolet rays generated by the sustain discharge excite the phosphor layer 125 disposed in the discharge cell 150, and the excited phosphor layer 125 emits visible light when it drops to a lower energy level. The light emitted from the discharge cells 150 in the PDP 100 therefore generates an image on the PDP 100.

When the potential difference between the front discharge electrodes 134 and the rear discharge electrodes 136 is lower than the discharge voltage, the sustain discharge may not be generated. However, charges and wall charges are disposed in the discharge cells 150. When the polarity of the pulses applied to the front discharge electrodes 134 and the rear discharge electrodes 136 is changed, the potential difference between the front discharge electrodes 134 and the rear discharge electrodes 136 plus the potential difference generated by the wall charges may equal or exceed the discharge voltage, and the sustain discharge may be generated. Therefore, if the pulse polarity is alternately applied to the front discharge electrodes 134 and the rear discharge electrodes 136, the sustain discharge may continue. A grey scale of each discharge cell 150 in the PDP 100 is determined by the duration and repetition of the sustain discharge.

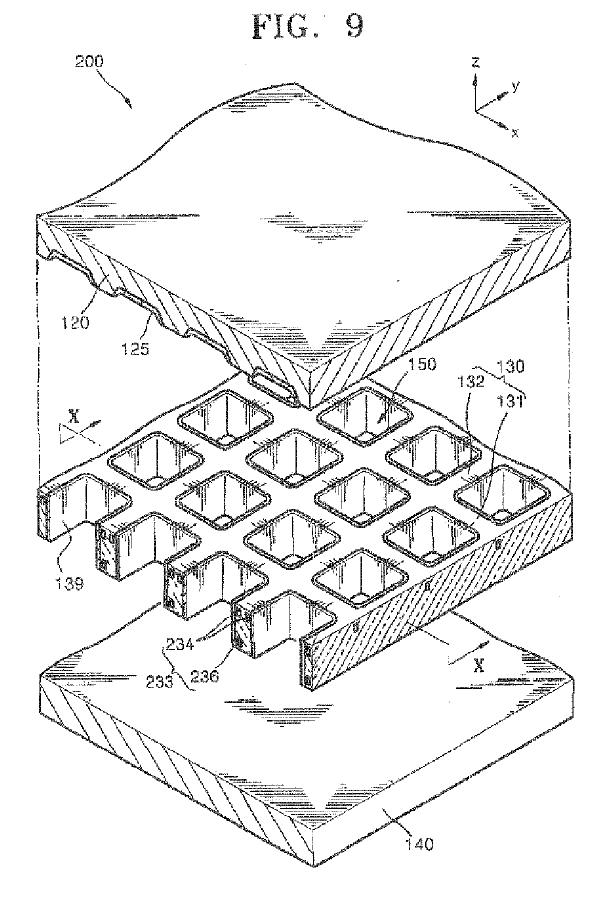

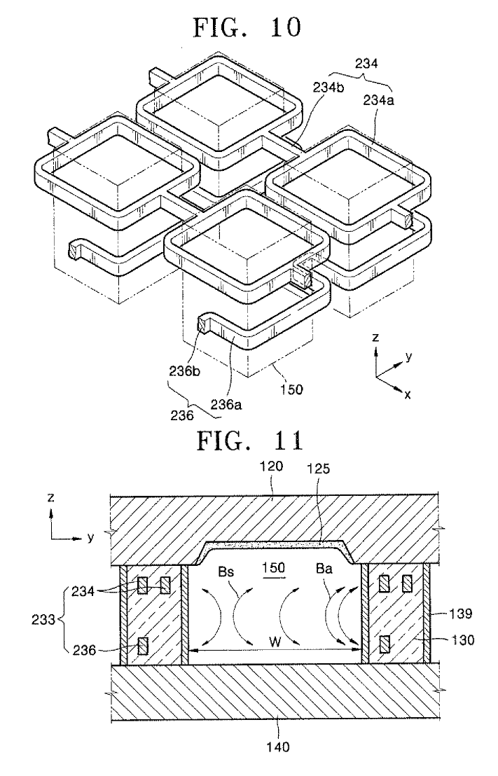

FIG. 9 is a partial exploded perspective view of a PDP 200 according to a second exemplary embodiment of the present invention. FIG. 10 is a perspective view illustrating the electrode arrangement of the PDP 200 shown in FIG. 9, and FIG. 11 is a cross-sectional view taken along line X-X of the PDP 200 shown in FIG. 9.

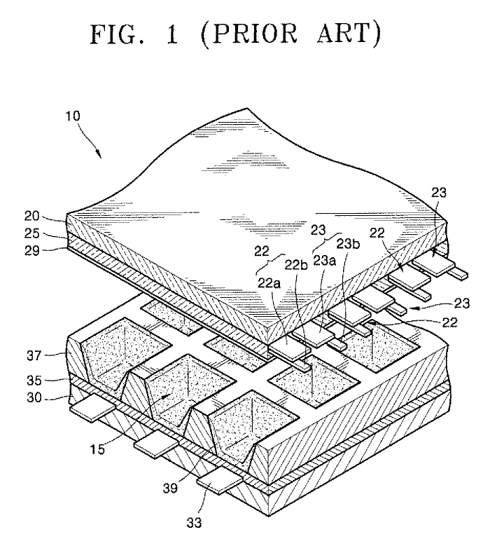

Referring to FIG. 9 through FIG. 11, the PDP 200 according to a second exemplary embodiment of the present invention includes a front substrate 120, an electrode group 233 including front discharge electrodes 234 and rear discharge electrodes 236 spaced apart from each other in the vertical direction (shown as the z direction in FIG. 9), a rear substrate 140, a dielectric wall 130 defining a plurality of discharge cells 150, a protection film 139 formed on the surfaces of the dielectric wall 130, a phosphor layer 125, and a discharge gas (not shown). Reference numerals common to FIG. 2 through FIG. 8 and FIG. 9 through FIG. 1 denote elements having the same function and configuration, and thus their description will not be repeated. The following description shall describe the differences between the first exemplary embodiment as shown in FIG. 2 through FIG. 9 and the second exemplary embodiment as shown in FIG. 9 through FIG. 1.

As shown in FIG. 10, the front discharge electrodes 234 can extend in a first direction (shown as the x direction in FIG. 10) and the rear discharge electrodes 236 can extend in a second direction (shown as the y direction in FIG. 10) to cross with the front discharge electrodes 234.

As with the first exemplary embodiment, either the front discharge electrodes 234 or the rear discharge electrodes 236 may function as scan electrodes, and the other may function as common electrodes. Additionally, either the front discharge electrodes 234 or the rear discharge electrodes 236 may function as address electrodes.

As shown in FIG. 10, the rear discharge electrodes 236 extend parallel to each other and each rear discharge electrode 236 may have an open horizontal cross-section that partially surrounds, but does not completely surround, a discharge cell 150. The invention is not limited hereto, and the front discharge electrodes 234 may be positioned with an open horizontal cross-section in this manner. The electrodes that partially surround the discharge cells 150 may serve as address electrodes.

As shown in FIG. 9 through FIG. 1, the rear discharge electrodes 236 may have the open horizontal cross-section corresponding to the discharge cells 150 and may serve as address electrodes. Additionally, the front discharge electrodes 234 extend in the first direction (shown as the x direction in FIG. 9) and the rear discharge electrodes 236 extend in the second direction (shown as the y direction in FIG. 9).

Each successive rear discharge electrode 236 extending in the second direction can be separately positioned in a second unit dielectric wall 132 also extending in the second direction. Therefore, a rear discharge electrode 236 corresponding to one discharge cell 150 and a rear discharge electrode 236 corresponding to the adjacent discharge cell 150 may be separated by at least the width W of the discharge cell 150 in the first direction. Accordingly, as will be described later, the rear discharge electrodes 236 may not unnecessarily increase the discharge current, thereby reducing power consumption and manufacturing cost.

As described above, if two rear discharge electrodes 236 corresponding to adjacent discharge cells 150 in the first direction are positioned within one unit dielectric wall 132, the distance between rear discharge electrodes 236 is reduced. Since the rear discharge electrodes 236 each may function as a polar plate, adjacent rear discharge electrodes 236 can function as a capacitor as described in more detail above.

As described above, if the distance between the rear discharge electrodes 236 increases, the capacitance is reduced. The reduction of the capacitance reduces the discharge current of the rear discharge electrodes 236. Thus, power consumption and heat generated by the rear discharge electrodes 236 can be reduced. The reduced power consumption also may allow for a smooth initial address discharge and increased control over an address voltage margin.

Therefore, a PDP having the above configuration has the following advantages.

First, the number of elements disposed on the front substrate is minimized, by positioning electrodes outside the conventional location on the emission path of visible light and inside the dielectric walls. Accordingly, the transmittance of the visible light and brightness may be greatly improved. Also, bright room contrast may be improved by blocking the reflection of external light back to the outside.

Second, the electrodes of the PDP need not be manufactured of ITO, which is expensive, thereby reducing manufacturing cost and enabling the manufacture of a large PDP without greatly increasing the cost of manufacturing.

Third, the discharge may be controlled to form a three dimensional discharge along all surfaces and the center of the discharge cell. Thus, a discharge with increased intensity can be achieved with a low driving voltage by increasing the distance between the front discharge electrodes and the rear discharge electrodes. Further, low voltage integrated circuit chips can be used, thereby reducing the manufacturing cost of the PDP.

Fourth, ion sputtering damage to the phosphor material can be reduced.

Fifth, the generation of heat by the address electrodes can be prevented, thereby reducing the power consumption. Also, the address voltage margin is improved by smoothly inducing the initial address discharge.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
a front substrate;
a rear substrate facing the front substrate;
a dielectric wall disposed between the front substrate and the rear substrate and including a first unit dielectric wall and a second unit dielectric wall, the dielectric wall defining a plurality of discharge cells;
a front discharge electrode disposed within the dielectric wall;
a rear discharge electrode disposed within the dielectric wall;
a plurality of address electrodes disposed within the dielectric wall, each having a portion corresponding to and partially surrounding a discharge cell;
a phosphor layer disposed in the discharge cell; and
a discharge gas disposed in the discharge cell,
wherein at least one of the front discharge electrode and the rear discharge electrode comprises a plurality of discharge electrode portions separated from each other.

2. The plasma display panel of claim 1,
wherein a first address electrode is disposed within the first unit dielectric wall, a second address electrode is disposed within the second unit dielectric wall and extends parallel to the first address electrode, and the first address electrode and the second address electrode are separated by at least a width of a discharge cell.

3. The plasma display panel of claim 1, wherein the front discharge electrode and the rear discharge electrode extend in a first direction and an address electrode extends in a second direction to cross with the front discharge electrode and the rear discharge electrode.

4. The plasma display panel of claim 3, wherein the first unit dielectric wall defines the discharge cells in the first direction, the second unit dielectric wall defines the discharge cells in the second direction crossing the first direction, and
the address electrode comprises:
a first discharge unit extending in a portion of the first unit dielectric wall between adjacent discharge cells; and
a second discharge unit extending in the second unit dielectric wall and coupled with the first discharge unit.

5. The plasma display panel of claim 1, wherein an address electrode is disposed between the front discharge electrode and the rear discharge electrode.

6. The plasma display panel of claim 1, wherein the dielectric wall surrounds and defines a perimeter of the discharge cell.

7. The plasma display panel of claim 6, wherein the front discharge electrode and the rear discharge electrode are disposed to surround the perimeter of the discharge cell.

8. The plasma display panel of claim 1, further comprising:
a protection film disposed in the discharge cell and covering at least a portion of the dielectric wall.

9. The plasma display panel of claim 1, wherein the phosphor layer is disposed in a groove formed in the front substrate.

10. The plasma display panel of claim 1, wherein the dielectric wall is coupled between a surface of the front substrate and a surface of the rear substrate.

11. A plasma display panel, comprising:
a front substrate;
a rear substrate facing the front substrate;
a dielectric wall disposed between the front substrate and the rear substrate and including a plurality of unit dielectric walls that define discharge cells in a first direction;
a plurality of first discharge electrodes and a plurality of second discharge electrodes disposed within the dielectric wall;
a phosphor layer disposed in a discharge cell; and
a discharge gas disposed in the discharge cell,
wherein a first discharge electrode has a portion corresponding to and partially surrounding a perimeter of the discharge cell.

12. The plasma display panel of claim 11, wherein the first discharge electrode functions as an address electrode.

13. The plasma display panel of claim 12, further comprising:
a first unit dielectric wall;
a second unit dielectric wall extending parallel to the first unit dielectric wall; and
a third discharge electrode positioned within the second unit dielectric wall,
wherein the first discharge electrode and the third discharge electrode are front discharge electrodes, a second discharge electrode is a rear discharge electrode, and the first discharge electrode is positioned within the first unit dielectric wall.

14. The plasma display panel of claim 12, further comprising:
a first unit dielectric wall;
a second unit dielectric wall extending parallel to the first unit dielectric wall; and
a third discharge electrode positioned within the second unit dielectric wall,
wherein the first discharge electrode and the third discharge electrode are rear discharge electrodes, a second discharge electrode is a front discharge electrode, and the first discharge electrode is positioned within the first unit dielectric wall.

15. The plasma display panel of claim 11, wherein the first discharge electrode extends in a first direction along a row of discharge cells, and a second discharge electrode extends in a second direction to cross with the first discharge electrode.

16. The plasma display panel of claim 15, wherein a unit dielectric wall comprises:
a first unit dielectric wall extending in a first direction; and
a second unit dielectric wall extending in a second direction, and
wherein the first discharge electrode comprises:
a first discharge unit extending in a portion of the first unit dielectric wall between adjacent discharge cells; and
a second discharge unit extending in the second unit dielectric wall and coupled with the first discharge unit.

17. The plasma display panel of claim 11, wherein the dielectric wall surrounds and defines a perimeter of the discharge cell.

18. The plasma display panel of claim 11, further comprising:
a protection film covering at least a portion of the dielectric wall.

19. The plasma display panel of claim 11, wherein the phosphor layer is disposed in a groove formed in the front substrate.

20. The plasma display panel of claim 11, wherein the dielectric wall is coupled between a surface of the front substrate and a surface of the rear substrate.
